(19) United States
(12) Patent Application Publication
(10) Pub. No.: US 2011/0166986 A1
(43) Pub. Date: Jul. 7, 2011

(54) Banking Center First Mortgage Origination

(75) Inventors: Gregory Lynn Graham, Huntersville, NC (US); Todd Raymond Henry, Waxhaw, NC (US)

(73) Assignee: Bank of America Corporation, Charlotte, NC (US)

(21) Appl. No.: 12/652,349

(22) Filed: Jan. 5, 2010

(51) Int. Cl. G06Q 40/00; G06Q 10/00

(52) U.S. Cl. 705/38; 705/35

(57) ABSTRACT

A financial institution may determine a first mortgage opportunity for a banking center within a market from market-level data. The market-level data for a market geographical area is obtained for customers originating a first mortgage within a predetermined time period and is typically anonymous while providing a credit score and indicator whether the associated customer is a customer of the financial institution and has conducted a transaction within a predetermined time duration. The market geographical area typically contains a plurality of financial centers for the financial institution. The market-level data is then filtered in order to determine a total mortgage opportunity for the financial institution. From information about the financial centers, the total mortgage opportunity is apportioned among the financial centers in the market. Resources may then be allocated to a financial center based on the estimated mortgage opportunity for the financial center.

### FIELD

Aspects of the embodiments generally relate to determining staffing for a mortgage origination process of a financial institution.

### BACKGROUND

Home sales are a major engine of the economy in the United States. For example, while the expected total mortgage production in 2008 is less than 2007, the amount is nearly $2 billion annually, and except for recent years, typically increases each year. A mortgage origination is an associated process, in which a borrower applies for a new loan for a home with a lender processing the mortgage application. A mortgage origination generally includes all the steps from taking a mortgage application through disbursal of funds (or declining the mortgage application). Loan servicing generally spans everything after disbursing the funds until the mortgage is fully paid off. Mortgage origination is typically a specialized version of new account opening for financial services organizations that often involve mortgage brokers and mortgage officers. Applications for mortgages may be processed through several different channels and the length of the application process is the time from initial application to funding, where different organizations may use various channels for customer interactions over time. In general, mortgage applications may be split into three distinct types, including agent-assisted (branch-based), agent-assisted (telephone-based), broker sale (third-party sales agent), and self-service.

Retail loans and mortgages are typically highly competitive products that may not individually offer a large margin to their providers, but through high volume sales, may be highly profitable to a financial institution. The business model of the individual financial institution and the products that the financial institution offers often affects the mortgage application model. Typical types of financial services organizations, including banks and credit unions, offer loans through the face to face channel that have a long-term investment in “brick and mortar” branches. The appeal to customers of the mortgage directly offered in branches is the long-standing relationship that a customer may have with the financial institution, the appearance of trustworthiness this type of institution has, and the perception that holding a larger portfolio of products with a single organization may lead to better terms. From a bank's standpoint, cross-selling products to current customers offers an effective marketing opportunity, and agents in branches may be trained to handle the sale of many different types of financial products. In a bank branch, customers typically sit with a mortgage officer who will assist the customer in completing the application form, selecting appropriate product options (such as payment terms and rates), collecting required documentation, selecting add-on products, and eventually signing a completed application. Dependent on the financial institution and product being offered, the mortgage application may be completed on a paper application form, or directly into an online application through the agent's desktop system.

Consequently, improving the efficiency of the mortgage origination process may result in improved earnings for the financial institution while benefiting customers and contributing the United States economy.

### BRIEF SUMMARY

Aspects of the embodiments address one or more of the issues mentioned above by disclosing methods, computer readable media, and apparatuses in which a financial institution determines a first mortgage opportunity for a banking center within a market from market-level data. The financial institution may include a bank, savings and loan association, a mortgage originator that is based on a dispersed retail store model, and a mortgage consultant.

With another aspect of the embodiments, market-level data for a market geographical area is obtained for customers originating a first mortgage within a predetermined time period. The market-level data is typically anonymous while providing a credit score and indicator whether the associated customer is a customer of the financial institution. The market geographical area typically contains a plurality of financial centers (e.g., banking centers). The market-level data is then filtered in order to determine a total mortgage opportunity for the financial institution within the market. From information about the financial centers, the total mortgage opportunity is apportioned among the financial centers in the market.

With another aspect of the embodiments, an apportioning factor is determined for each financial center in a market. The factors are summed over the market and the mortgage opportunity for each financial center is estimated as being proportional to the financial center's factor with respect to the sum of the factors. With some embodiments, the apportioning factor for the financial center is equal to the number of users for the financial center multiplied by a home ownership rate and further multiplied by a home value measure for a geographical area serviced by the financial center.

With another aspect of the embodiments, resources are allocated to a financial center based on the mortgage opportunity for the financial center. Consequently, a mortgage staff may be assigned to the financial center.

Aspects of the embodiments may be provided in a computer-readable medium having computer-executable instructions to perform one or more of the process steps described herein.

These and other aspects of the embodiments are discussed in greater detail throughout this disclosure, including the accompanying drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative operating environment in which various aspects of the embodiments may be implemented.

FIG. 2 is an illustrative block diagram of workstations and servers that may be used to implement the processes and functions of certain aspects of the embodiments.

FIG. 3 shows a flow diagram for a first mortgage origination process in accordance with various aspects of the embodiments.

FIG. 4 shows an exemplary scenario that estimates the mortgage opportunity for first mortgage originations in accordance with various aspects of the embodiments.

FIG. 5 shows a flow diagram for filtering market-level data in accordance with various aspects of the embodiments.

FIG. 6 shows a flow diagram for apportioning a total mortgage opportunity to each of the financial centers in accordance with various aspects of the embodiments.

FIG. 7 shows a flow diagram for allocating resources to financial centers in accordance with various aspects of the embodiments.

### DETAILED DESCRIPTION

In accordance with various aspects of the embodiments, methods, computer-readable media, and apparatuses are disclosed in which a financial institution determines a first mortgage opportunity for a banking center within a market area from market-level data. Moreover, embodiments may support other types of loans including second mortgages and home equity loans. A market typically contains a plurality of banking centers, for example, 30-50 banking centers, where each banking center serves a smaller geographical area within the market area.

Embodiments of the invention support financial institutions, including banks and savings and loan associations (often referred as thrifts). However, some embodiments may support financial institutions that originate mortgages through a dispersed retail store model and consultants in the first mortgage sales industry.

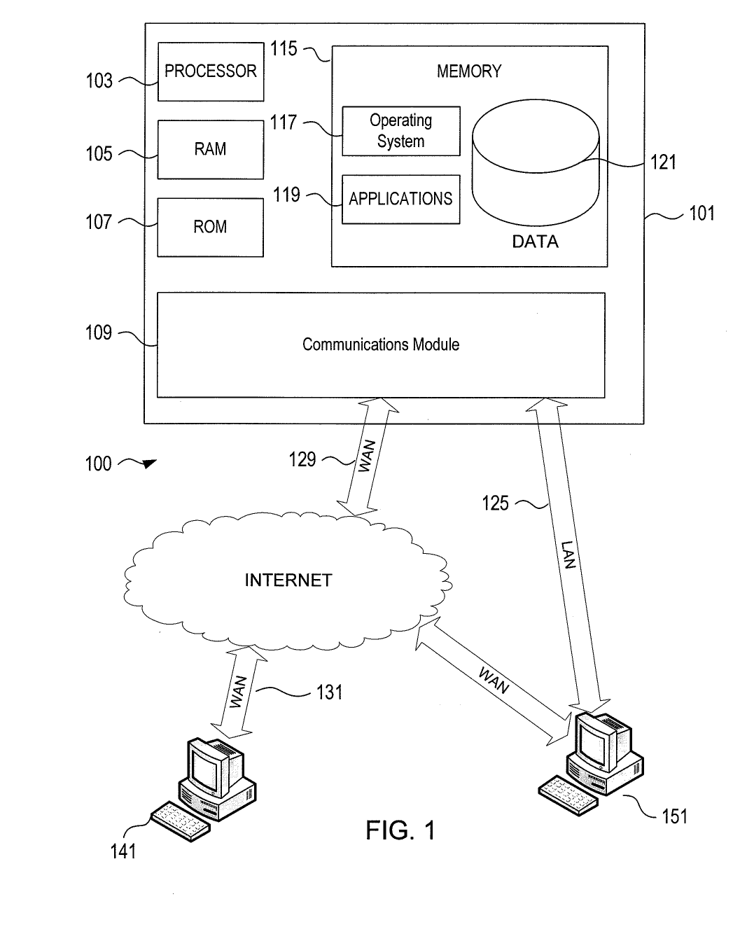

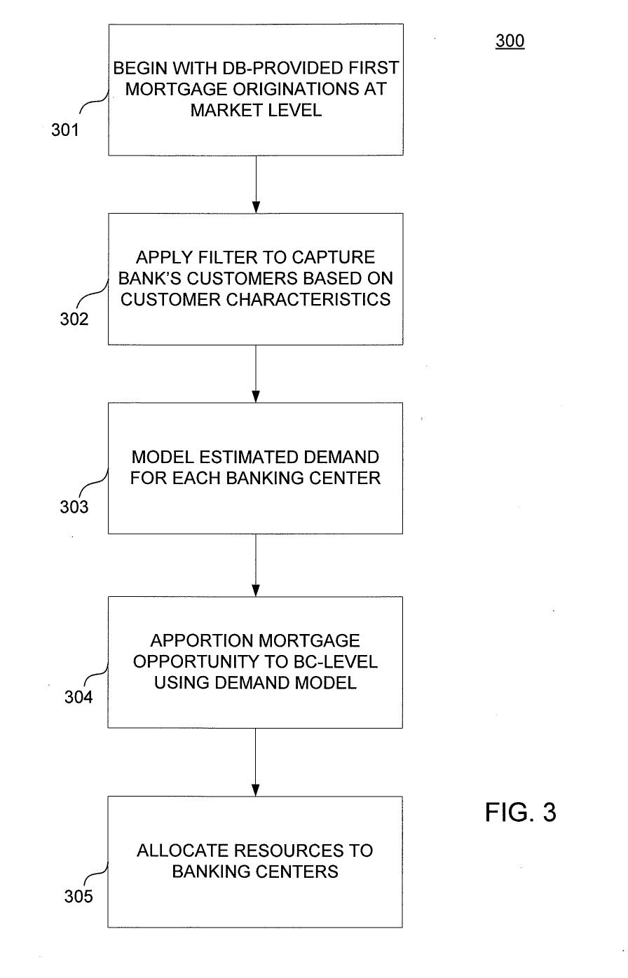

FIG. 1 illustrates an example of a suitable computing system environment 100 (e.g., for supporting exemplary scenario 400 and processes 300, 500, 600, and 700 as shown in FIGS. 3, 5, 6, and 7, respectively) that may be used according to one or more illustrative embodiments. The computing system environment 100 is only one example of a suitable computing environment and is not intended to suggest any limitation as to the scope of use or functionality of the embodiments. The computing system environment 100 should not be interpreted as having any dependency or requirement relating to any one or combination of components shown in the illustrative computing system environment 100.

The embodiments are operational with numerous other general purpose or special purpose computing system environments or configurations. Examples of well known computing systems, environments, and/or configurations that may be suitable for use with the embodiments include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including RAM 105, ROM 107, communications module 109, and memory 115. Computing device 101 typically includes a variety of computer readable media. Computer readable media may be any available media that may be accessed by computing device 101 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 100 may also include optical scanners (not shown). Exemplary usages include scanning and converting paper documents, e.g., correspondence, receipts, etc. to digital files.

Although not shown, RAM 105 may include one or more are applications representing the application data stored in RAM memory 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Alternatively, some or all of the computer executable instructions for computing device 101 may be embodied in hardware or firmware (not shown).

Database 121 may provide centralized storage of market-level data. Processor 103 may access the market-level data from database 121 and process the market-level data according to filtering parameters, e.g., a credit score threshold, as will be further discussed. While database 121 is shown to be internal to computing device 101, database 121 may be external to computing device 101 with some embodiments.

Computing device 101 may operate in a networked environment supporting connections to one or more remote computing devices, such as branch terminals 141 and 151. The branch computing devices 141 and 151 may be personal computing devices or servers that include many or all of the elements described above relative to the computing device 101.

The network connections depicted in FIG. 1 include a local area network (LAN) 125 and a wide area network (WAN) 129, but may also include other networks. When used in a LAN networking environment, computing device 101 is connected to the LAN 825 through a network interface or adapter in the communications module 109. When used in a WAN networking environment, the server 101 may include a modem in the communications module 109 or other means for establishing communications over the WAN 129, such as the Internet 131. It will be appreciated that the network connections shown are illustrative and other means of establishing a communications link between the computing devices may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages. The network connections may also provide connectivity to a CCTV or image/iris capturing device.

Additionally, one or more application programs 119 used by the computing device 101, according to an illustrative embodiment, may include computer executable instructions for invoking user functionality related to communication including, for example, email, short message service (SMS), and voice input and speech recognition applications.

Embodiments of the invention may include forms of computer-readable media. Computer-readable media include any available media that can be accessed by a computing device 101. Computer-readable media may comprise storage media and communication media. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, one of ordinary skill in the art will appreciate that various aspects described herein may be embodied as a method, a data processing system, or as a computer-readable medium storing computer-executable instructions. For example, a computer-readable medium storing instructions to cause a processor to perform steps of a method in accordance with aspects of the embodiments is contemplated. For example, aspects of the method steps disclosed herein may be executed on a processor on a computing device 101. Such a processor may execute computer-executable instructions stored on a computer-readable medium.

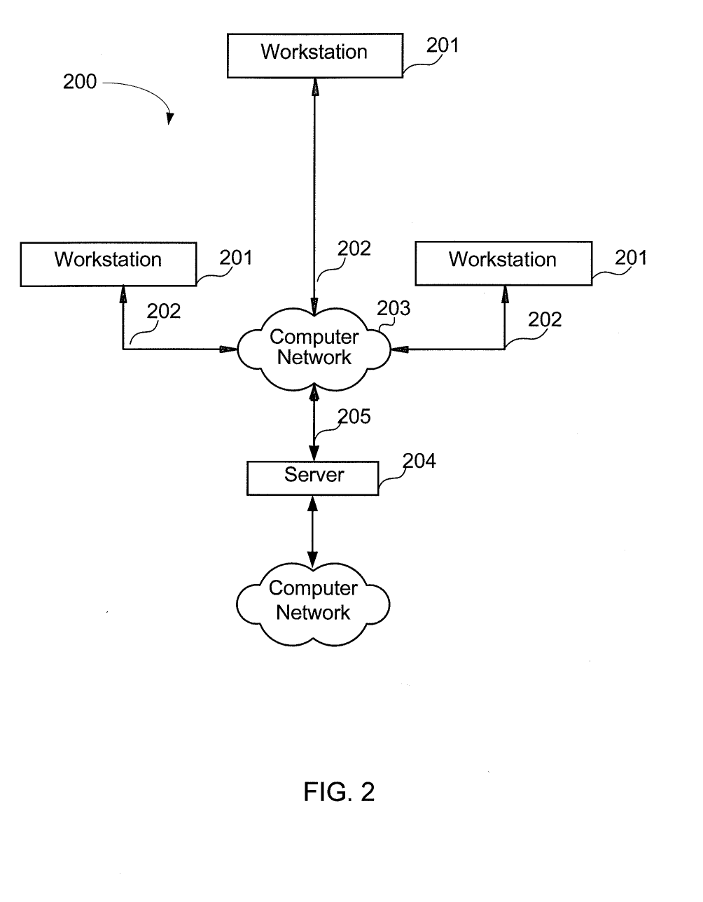

Referring to FIG. 2, an illustrative system 200 for implementing methods according to some embodiments is shown. As illustrated, system 200 may include one or more workstations 201. Workstations 201 may be local or remote, and are connected by one of communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc. Connectivity may also be supported to a CCTV or image/iris capturing device.

As understood by those skilled in the art, the steps that follow in the Figures may be implemented by one or more of the components in FIGS. 1 and 2 and/or other components, including other computing devices.

FIG. 3 shows flow diagram 300 for a first mortgage origination process in accordance with various aspects of the embodiments. Process 300 estimates the first mortgage origination opportunity for each banking center in the franchise (e.g., market area). As a result, the financial institution may design a banking center sales strategy based on volume opportunity for first mortgages. A demand model may also help in setting banking center level mortgage goals and other performance based analytics.

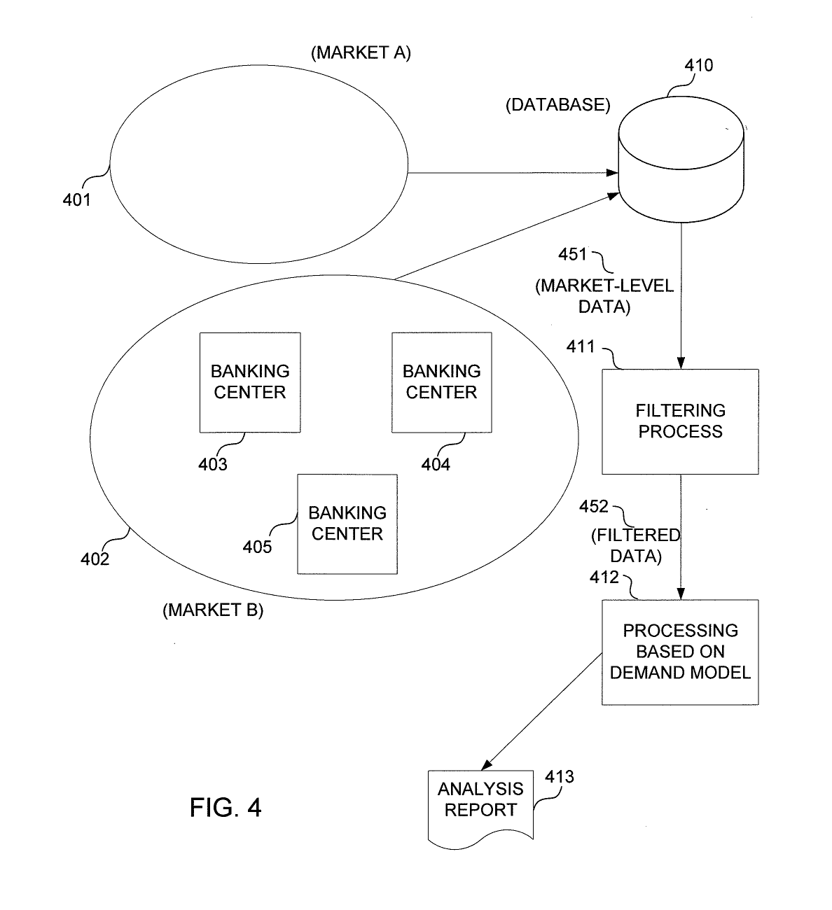

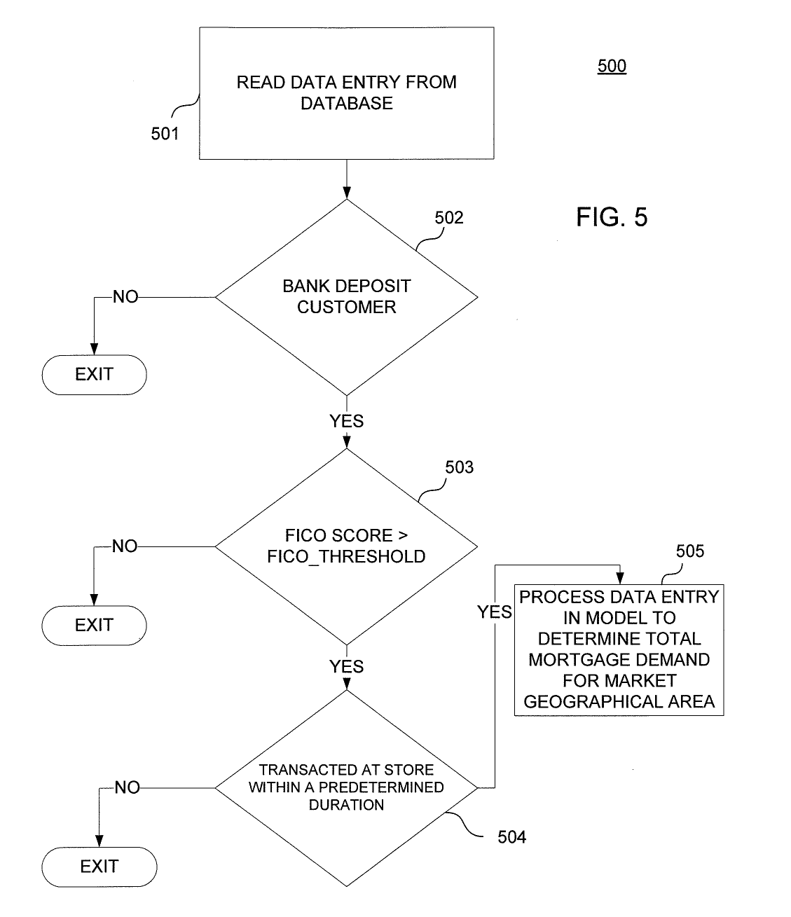

In block 301, first mortgage dollar origination data at a market-level is obtained from database 410 as shown in FIG. 4. For example, credit bureau data may be sampled, e.g., 1 of every 9 data samples. For example, the data may include county-level originations based on deed records. However, with traditional systems, the data is not filtered based on customer type, risk metrics, or transaction behavior. In block 302, the data is filtered to capture a financial institution's customers based on customer characteristics as will be further discussed with process 500 as shown in FIG. 5.

In block 303, a demand model is constructed for each banking center (financial center) in a market area (e.g., banking franchise). A typical market area may contain thirty to fifty or more banking centers. With some embodiments, each banking center has full service capability and is located in a “brick and mortar” facility with one or more employees. The demand for each banking center may be based on various characteristics for the financial center, including teller users, median home values, and owner occupancy rates.

In block 304, a first mortgage opportunity is apportioned to each banking center using the demand model as constructed in block 303. Consequently, step 304 estimates the mortgage opportunity to a smaller geographic level than is typically provided by traditional systems. In block 305, Resources may then be allocated to each banking center based on the mortgage opportunity apportioned to the banking centers. For example, if 10 million dollars of mortgage opportunity were apportioned to a first banking center and 20 million dollars of mortgage opportunity were apportioned to a second banking center, more resources would probably be allocated to the second banking center, although the amount of allocated resources may not be linear to the estimated mortgage opportunity. Allocated resources may encompass different resource types including staff (e.g., mortgage officers) and associated equipment (e.g., computers).

Embodiments may support banks and saving and loan associations as well as financial institutions that originate mortgages through a dispersed retail store model and consultants in the first mortgage sales industry.

FIG. 4 shows exemplary scenario 400 that estimates the mortgage opportunity for first mortgage originations in accordance with various aspects of the embodiments. Database 410 stores sampled credit bureau data for first mortgage originations during a predetermined time period (e.g., for the last calendar year) at a market-level for market geographical area 401 and market geographical area 402. While FIG. 4 depicts a scenario with first mortgage originations, embodiments may support other types of consumer loans, including home equity loans and second mortgages. While the data contains credit score information for a customer, the data entries are typically anonymous to ensure the privacy of the customers. Each data entry contains an indicator whether the associated customer is a customer of a financial institution (e.g., a bank), and, if so, whether the customer has made a transaction with a banking center within the market geographical area.

With exemplary scenario 400, the financial institution processes market-level data 451 from database 410 for market geographical area 402, which contains banking centers 403, 404, and 405. The applied methodology in scenario 400 is distinguished from traditional systems in that it allocates the first mortgage opportunity to the banking center level. The constructed model estimates mortgage demand to a smaller geographic level than other sources. While FIG. 4 depicts only three banking centers with area 402, embodiments may support a greater number of banking centers, typically thirty to fifty banking centers in a market.

Filtering process 411 filters market-level data 451 to obtain filtered data 452 by extracting entries that are for the financial institution's customers that made a transaction at one of the financial centers within market geographical area 402. Embodiments may filter market-level in accordance with additional criteria or different criteria. For example, data entries may be further extracted for processing only if the associated customer has a credit rating above a predetermined credit score as will be further discussed.

With an exemplary embodiment, filtering process 411 filters market-level data to include only first mortgages that are originated by a bank's customers with a FICO score above 660 and who transacted at a banking center in the last 90 days. Filtered data 452 is thus provided at the bank-defined consumer market level. The mortgage opportunity for the market is then apportioned by process 412 to the banking centers (e.g., banking centers 403-405) in the market by process 412 using banking center level traffic and demographic data (which may be proprietary to the financial institution). Results from process 412 are used to generate analysis report 413 in which resources for originating mortgages are distributed to the different banking centers in a market based on the modeled mortgage demand.

FIG. 5 shows flow diagram 500 for filtering market-level data in accordance with various aspects of the embodiments. In block 501 market-level data for first mortgage originations in market geographical area 402 is accessed from database 410. If an associated customer (e.g., bank deposit customer) for an entry is associated with the financial institution (e.g., a bank), as determined by block 502, then the entry is further processed. Otherwise, the entry is ignored.

Entries are further processed by comparing the credit score (e.g., a FICO score) of the associated customer with a predetermined credit score threshold (e.g., 660) in block 503. A credit score in the United States is typically a number representing the creditworthiness of a person or the likelihood that person will pay his or her debts. A credit score is primarily based on a statistical analysis of a person's credit report information, typically from the three major American credit bureaus: Equifax, Experian, and TransUnion. The Fair Isaac Corporation, known as FICO, created the first credit scoring system that provides a basis for a FICO score, which typically ranges from 300 to 850. Entries are further processed in block 504 by determining whether the bank deposit customer has conducted a transaction at a store within a predetermined duration (e.g., within the last 90 days).

Block 505 then determines the total mortgage opportunity for the associated market geographical area, which typically contains a plurality of banking centers. As will be discussed, process 600 apportions the total mortgage opportunity to each of the banking centers to estimate a mortgage demand for each banking center. The total mortgage opportunity may be predicted on different assumptions regarding mortgage in the future. For example, a growth factor for mortgage demand in the subsequent year may be projected to be constant (i.e., remain the same) or to increase or decrease by a projected rate.

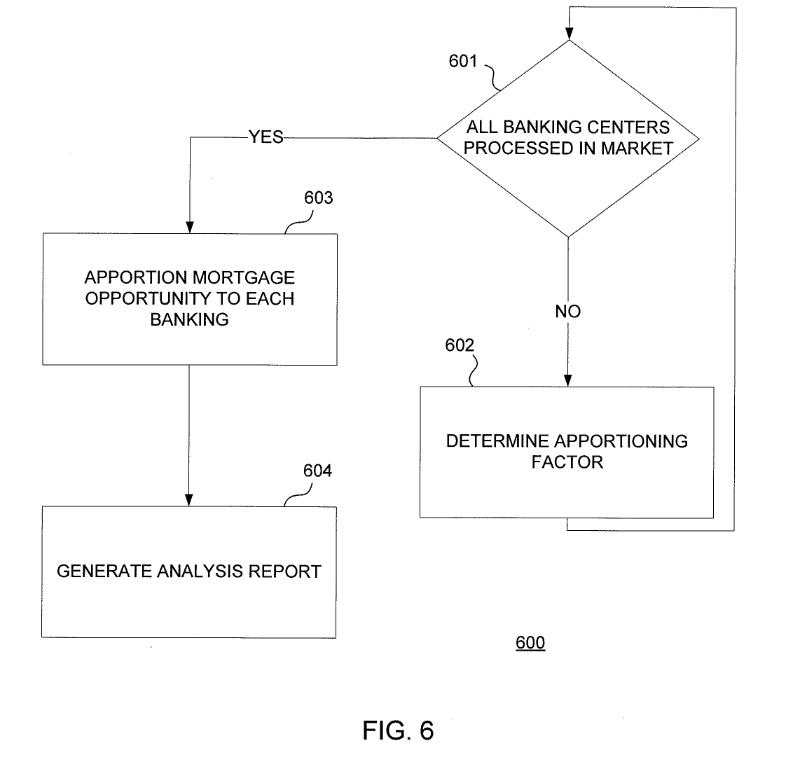

FIG. 6 shows flow diagram 600 for apportioning a total mortgage opportunity to each of the financial centers in accordance with various aspects of the embodiments. In block 601, all filtered entries, which span all of the banking centers in market geographical area 402, are processed. Block 601 determines whether all of the banking centers have been processed. If not, an apportioning factor of the next banking center (typically identified by an identification number) is determined in block 602.

In block 602, the apportioning factor for a given banking center may be determined based on internal data for the banking center. For example, the apportioning factor may be determined by multiplying the number of teller users at the banking center by the home ownership rate and further by the median home value in the area served by the banking center. The apportioning factor (BCFᵢ) for the i^{th} banking center may be expressed as:

BCFᵢ=number_userᵢ×home_ownership_rateᵢ×median_home_valueᵢ (EQ. 1)

The above calculation for EQ. 1 is performed in block 602 for all banking centers (1, 2, . . . , N) in the market.

When apportioning factors BCFᵢ have been determined for all banking centers in the market, block 603 is performed to apportion the total mortgage opportunity to each of the banking centers. The apportioning factors for the banking centers in a market are summed and a proportion of the market total is calculated for each banking center in block 603. The total mortgage opportunity (as determined in block 504 as previously discussed) is then allocated to each banking center based on the banking center's proportion of the market. For example, the mortgage opportunity for the k^{th} banking center is determined by:

mortgage_opportunityₖ=BCFₖ/ΣBCFᵢ×total_mortgage_opportunity (EQ. 2)

An analysis report is then generated in block 604 from the estimated mortgage opportunities for each banking center as exemplified in Table 1. Table 1 illustrates processes 500 and 600 in which the total mortgage opportunity, as determined by block 504, is equal to $30M with the number of teller users, home ownership rate, and median home value as shown for banking centers 403, 404, and 405. The mortgage opportunity for banking centers 403, 404, and 405 are estimated as $12.9M, $13.9M, and $3.2M, respectively, from EQ. 1 and EQ. 2.

TABLE 1
EXAMPLE FOR DETERMINING MORTGAGE OPPORTUNITY
FOR BANKING CENTERS FROM MARKET-LEVEL DATA
(TOTAL MORTGAGE OPPORTUNITY = $30M)

| | | Home | | | Mortgage |
|---|---|---|---|---|---|
| Banking | Teller | Ownership | Median | Apportioning | Opportunity |
| Center | Users | Rate | Home Value | Factor | for BC |
| BC 403 | 3000 | 0.60 | $250000 | 450M | $12.9M |
| BC 404 | 2000 | 0.75 | $325000 | 487.5M | $13.9M |
| BC 405 | 1000 | 0.50 | $225000 | 112.5M | $3.2M |

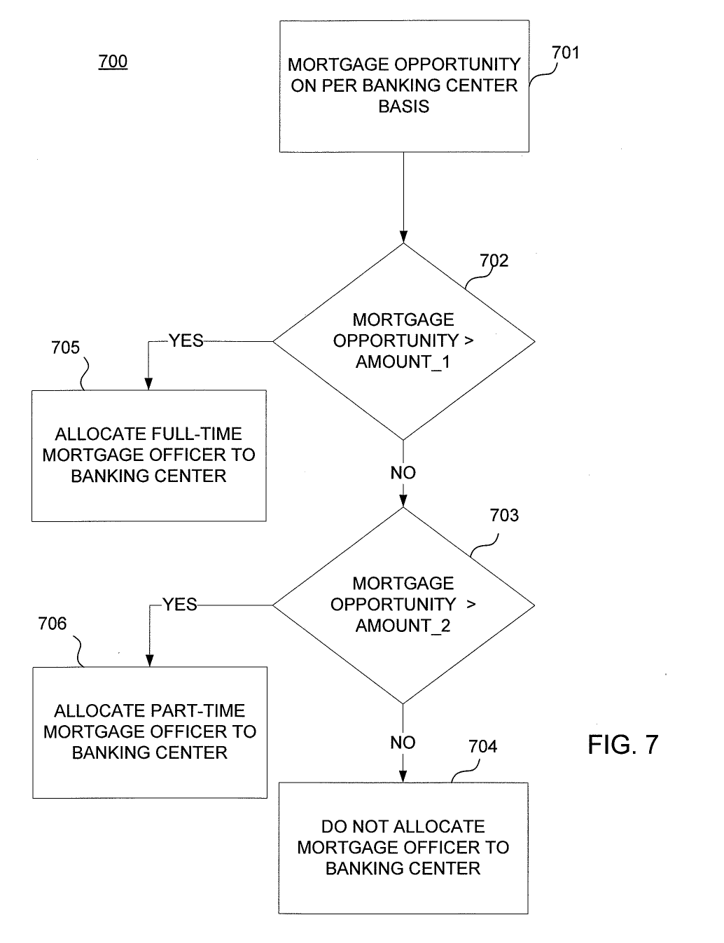

FIG. 7 shows flow diagram 700 for allocating resources to a financial center based on the mortgage opportunity in accordance with various aspects of the embodiments. Block 701 obtains the mortgage opportunities for the banking centers from block 604 as shown in FIG. 6. In block 702, if the mortgage opportunity for a banking center exceeds a first predetermined amount, then a full-time mortgage officer is assigned to the banking center in block 705. Otherwise, if the mortgage opportunity exceeds a second predetermined amount (which is less than the first predetermined amount) as determined in block 703, then a part-time mortgage officer is assigned to the banking center in block 706. Otherwise, no mortgage resources are allocated to the banking center in block 704.

Extending the example shown in Table 1 to process 700, if amount_1 were equal to $10M and amount_2 is $3M, then a full-time mortgage officer is assigned to banking center 403 and to banking center 404. However, no mortgage officer is assigned to banking center 405 because the financial institution has deemed that the mortgage opportunity does not warrant any mortgage resources. In such a case, banking center 405 may refer a customer to centralized sales.

Aspects of the embodiments have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the embodiments.

We claim:

1. A computer-assisted method comprising:
obtaining market-level data for a market geographical area, wherein the market-level data includes information for customers originating a mortgage within a predetermined time period and wherein the market-level data has a resolution only to the market geographical area;
filtering, by a processor, the market-level data to obtain filtered data, wherein the filtered data is based on at least one criterion specific to a financial institution; and
estimating, by the processor, an estimated mortgage opportunity for a financial center of the financial institution from the filtered data, wherein a plurality of financial centers of the financial institution are located in the market geographical area and wherein each financial center serves an area smaller than the market geographical area.

2. The method of claim 1, wherein the estimating includes:
determining a total mortgage opportunity for the plurality of financial centers; and
apportioning a portion of the total mortgage opportunity to the financial center to obtain the estimated mortgage opportunity

3. The method of claim 1, wherein the financial institution comprises a bank and the financial center comprises a banking center.

4. The method of claim 2, further comprising:
determining an apportioning factor for each financial center of the financial institution in the market geographical area.

5. The method of claim 4, wherein the determining the apportioning factor comprises multiplying a number of users by a home ownership rate by a home value measure for a geographical area serviced by the financial center.

6. The method of claim 4, wherein the estimating of the estimated mortgage opportunity for the financial center comprises:
determining an apportioning ratio equal to the apportioning factor divided by a sum of apportioning factors for all financial centers within the market geographical area; and
multiplying the total mortgage opportunity for the market geographical area by the apportioning ratio.

7. The method of claim 1, wherein the filtering comprises:
processing an entry of the market-level data only if the entry is associated with a customer of the financial institution.

8. The method of claim 7, wherein the filtering further comprises:
processing the entry only if the customer has a credit score greater than a predetermined credit threshold.

9. The method of claim 1, further comprising:
when the estimated mortgage opportunity for the financial center is greater than a first predetermined amount, assigning a full-time mortgage person to the financial center.

10. The method of claim 9, further comprising:
when the estimated mortgage opportunity is not greater than the first predetermined amount and greater than a second predetermined amount, assigning a part-time mortgage person to the financial center.

11. The method of claim 1, wherein filtering is performed only when a customer has performed a transaction with one of the plurality of financial centers within a predetermined time duration.

12. A computer-readable storage medium storing computer-executable instructions that, when executed, cause a processor to perform a method comprising:
obtaining market-level data for a market geographical area, wherein the market-level data includes information for customers originating a first mortgage within a predetermined time period and wherein the market-level data has a resolution only to the market geographical area;
filtering the market-level data to obtain filtered data, wherein the filtered data is based on at least one criterion specific to a financial institution;
determining a total mortgage opportunity for a plurality of financial centers of the financial institution, wherein the plurality of financial centers are located in the market geographical area and wherein each financial center serves an area smaller than the market geographical area; and
apportioning a portion of the total mortgage opportunity from the filtered data to a financial center to obtain an estimated mortgage opportunity for the financial center.

13. The computer-readable medium of claim 12, said method further comprising:
determining an apportioning factor for each financial center of the financial institution in the market geographical area.

14. The computer-readable medium of claim 13, said method further comprising:
multiplying a number of users by a home ownership rate by a home value measure for a geographical area serviced by the financial center to obtain the apportioning factor.

15. The computer-readable medium of claim 14, said method further comprising:
determining an apportioning ratio equal to the apportioning factor divided by a sum of apportioning factors for all financial centers in the market geographical area; and
multiplying the total mortgage opportunity for the market geographical area by the apportioning ratio.

16. The computer-readable medium of claim 12, said method further comprising:
processing an entry from the market-level data only if a customer has a credit score greater than a predetermined credit threshold.

17. The computer-readable medium of claim 12, wherein the financial institution comprises a bank and the financial center comprises a banking center.

18. An apparatus comprising:
a memory; and
a processor coupled to the memory and configured to perform, based on instructions stored in the memory:
obtaining market-level data for a market geographical area, wherein:
the market-level data includes information for customers originating a first mortgage within a predetermined time period;
the market-level data has a resolution only to the market geographical area;
a plurality of financial centers of a financial institution are located within the market geographical area; and
each financial center serves a geographical area that is smaller than the market geographical area;
extracting filtered data from the market-level data only when a customer has performed a transaction with one of the plurality of financial centers within a predetermined time duration;
estimating an estimated mortgage opportunity for a financial center of the financial institution from the filtered data, wherein a plurality of financial centers of the financial institution are located in the market geographical area; and
assigning resources to the financial center based on the mortgage opportunity.

19. The apparatus of claim 18, wherein the processor is further configured to perform:
determining a total mortgage opportunity for the plurality of financial centers; and
apportioning a portion of the total mortgage opportunity to the financial center.

20. The apparatus of claim 19, wherein the processor is further configured to perform:
determining an apportioning factor for each financial center of the financial institution in the market geographical area.

21. The apparatus of claim 20, wherein the processor is further configured to perform:
determining an apportioning ratio equal to the apportioning factor divided by a sum of apportioning factors for all financial centers in the market geographical area; and
multiplying a total mortgage opportunity for the market geographical area by the apportioning ratio to obtain the estimated mortgage opportunity for the financial center.
